(19) United States
(12) Patent Application Publication
(10) Pub. No.: US 2016/0232588 A1
(43) Pub. Date: Aug. 11, 2016

(54) CONSUMER VERIFICATION

(71) Applicant: Robert C. Harmer, San Jose, CA (US)

(72) Inventor: Robert C. Harmer, San Jose, CA (US)

(21) Appl. No.: 14/614,878

(22) Filed: Feb. 5, 2015

(51) Int. Cl. G06Q 30/06; G06Q 50/12; G06Q 10/02

(52) U.S. Cl. CPC G06Q 30/0609; G06Q 10/02; G06Q 50/12

(57) ABSTRACT

A consumer commitment is verified by sending a computer generated confirmation message in response to a consumer making the consumer commitment. The computer generated confirmation message contains a link to a web page reiterating the consumer commitment. Upon the consumer selecting the link in the computer generated confirmation message containing, information identifying the consumer is collected. A verification code is sent electronically to the consumer upon the consumer confirming the consumer commitment reiterated on the web page. Upon the consumer entering the verification code, there is stored information containing the consumer commitment, a record of the verification process and the collected information identifying the consumer to verify the consumer commitment.

### BACKGROUND

Commercial transactions are increasingly being conducted electronically over the Internet. E-commerce web sites include product display, online ordering, online reservations and inventory management. To implement an E-commerce Web site, software resides on an e-commerce server. Online payment services are available to process payments. E-commerce can be conducted between business or between a business and consumers.

### BRIEF DESCRIPTION OF THE DRAWINGS

FIG. 1 is a simplified block diagram illustrating network connections between consumers and e-commerce servers in accordance with an implementation.

FIG. 2 is a simplified block diagram illustrating functional blocks within an e-commerce server in accordance with an implementation.

FIG. 3 is a simplified flow chart illustrating transaction confirmation in accordance with an implementation.

FIG. 4, FIG. 5, FIG. 6 and FIG. 7 illustrate an interface used for transaction confirmation in accordance with an implementation.

FIG. 8 is a simplified flow chart illustrating transaction confirmation/validation in accordance with another implementation.

### DESCRIPTION OF THE EMBODIMENT

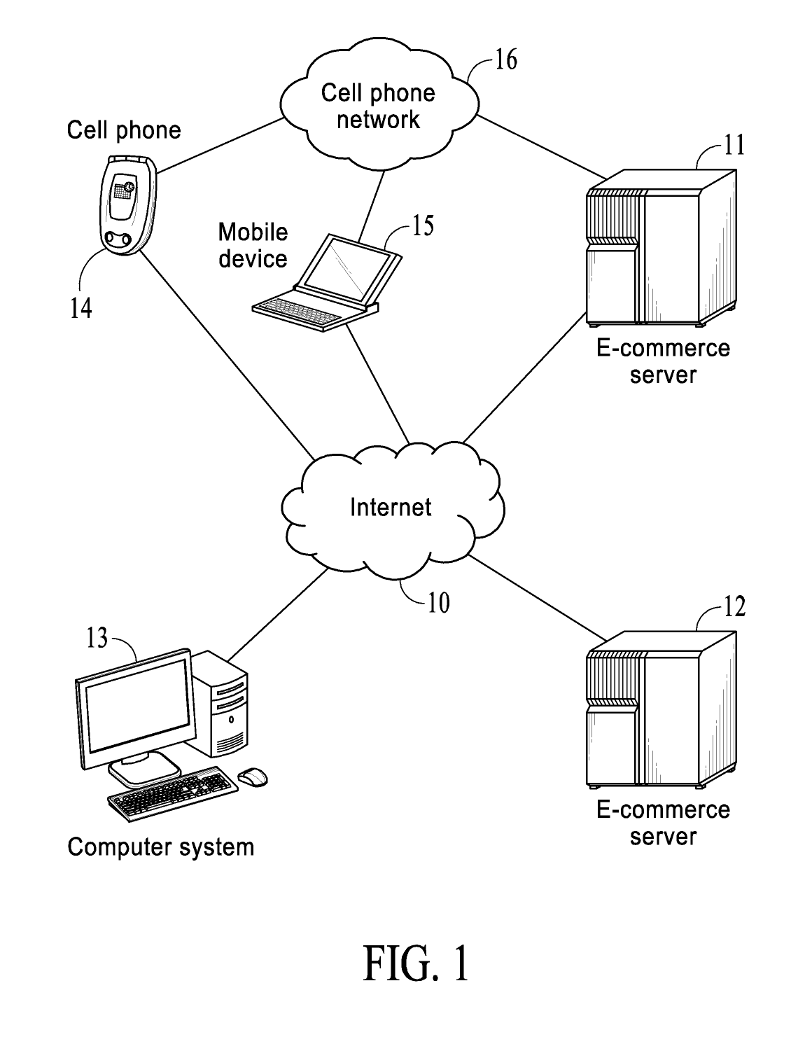

FIG. 1 is a simplified block diagram illustrating network connections between consumers and e-commerce servers. An e-commerce server 11 and an e-commerce server 12 are shown connected to the Internet 10. Consumers can communicate with e-commerce server 11 and an e-commerce server 12 through the Internet 10. This is illustrated in FIG. 1 by a cell phone 14, a mobile device 15 and a computer system 13 connected to the Internet 10. The mobile device 15 can be, for example, a tablet computer, a portable computer, a smart phone, etc. Computer system 13 can be a desktop computer, a laptop computer or another type of computer.

In addition to communication through the Internet 10, cell phone 14 and mobile device 15 are shown being in communication with e-commerce server 11 via a cell phone network 16. For example, e-commerce server 11 can use cell phone network 16 to send short message service (SMS) text messages to cell hone 14 or mobile device 15.

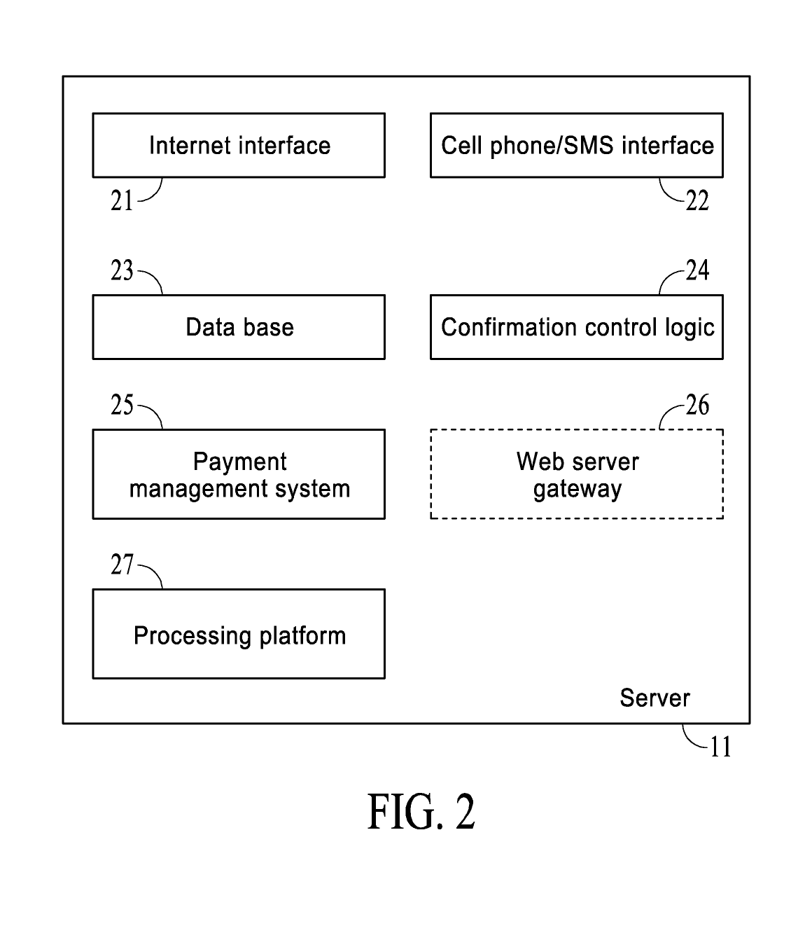

FIG. 2 is a simplified block diagram illustrating functional blocks within e-commerce server 11. For example, e-commerce server 11 includes an internet interface block 21, a cell phone and SMS interface block 22, a database 23 and confirmation control logic 24. For example, database 23 is a reservation database for a hotel or hotel chain and confirmation control logic 24 implements transaction confirmation for hotel or other accommodation reservations, car reservations, or some other type of reservation. For example e-commerce system 11 can also use a payment management system (PMS) 25. Alternatively, PMS 25 may be located on another e-commerce server or gateway used for financial transactions and made available through the Internet 10 or through another network.

Alternative to use for a reservation system, database 23 can store information pertaining to the purchase of goods and services. Information stored can include, for example, purchase price, terms and conditions, description of product or service, purchase data, shipping and tracking information, and additional information a merchant would want a consumer to validate. In this case e-commerce server 11, or another server, might contain a web server gateway 26 that uses an application programming interface (API) as a single entry for all clients such as a payment gateway or financial transaction platform. When a transaction is done through gateway 26, the transaction is authorized when the consumer inputs information and is “captured” once confirmation is completed. A processing platform 27 can also be available within e-commerce server 11. For example, processing platform 27 is used to process on-line payments,

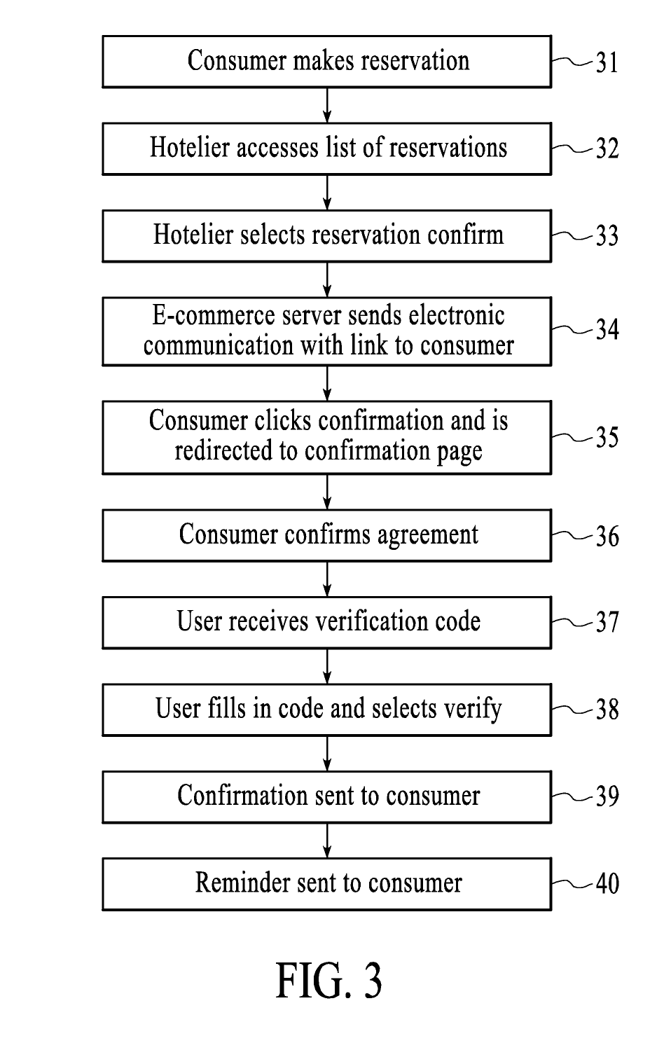

FIG. 3 is a simplified flow chart illustrating transaction confirmation as implemented by confirmation control logic 24.

In a block 31 a reservation is made. For example, a consumer can initiate a reservation through interaction with e-commerce server 11 through the Internet 10. Alternatively, for example, a hotelier can initiate a new reservation for their respective hotel by entering the consumer contact information and the reservation information.

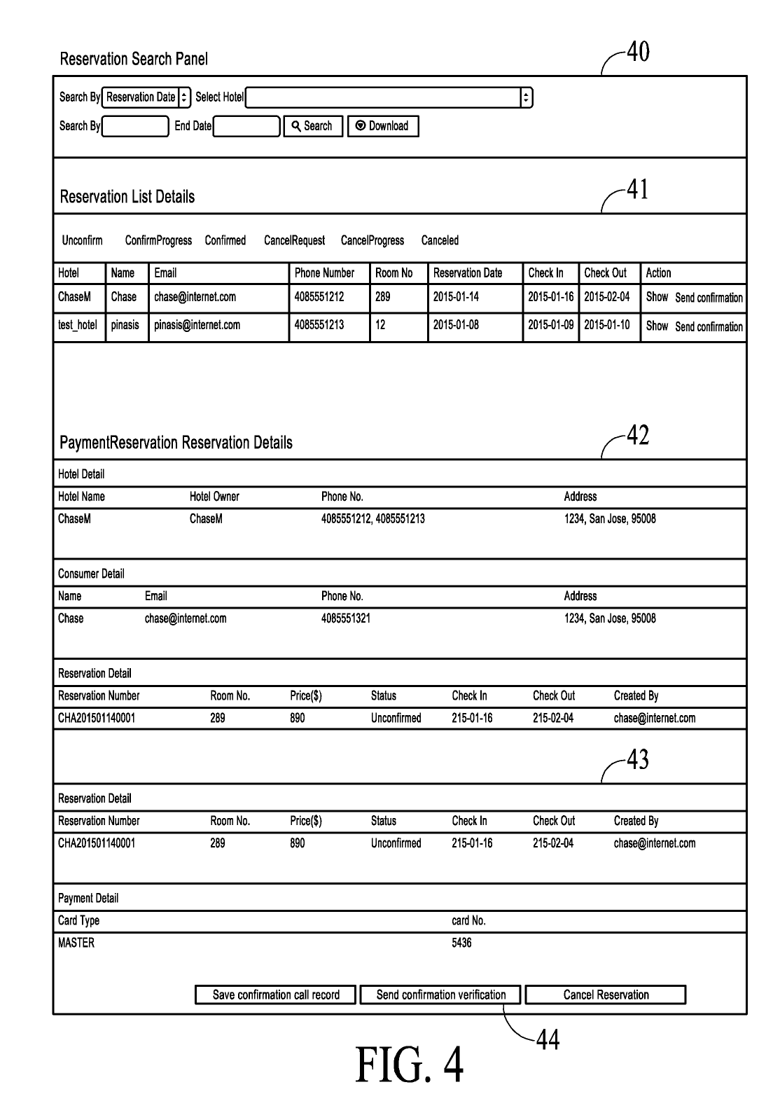

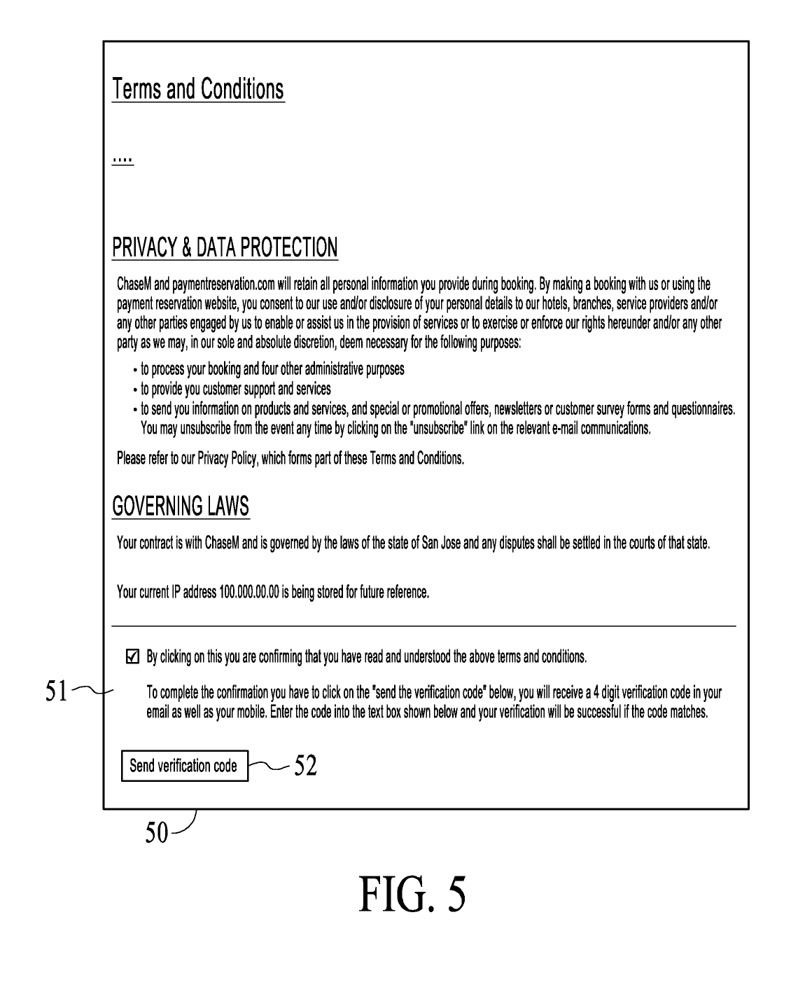

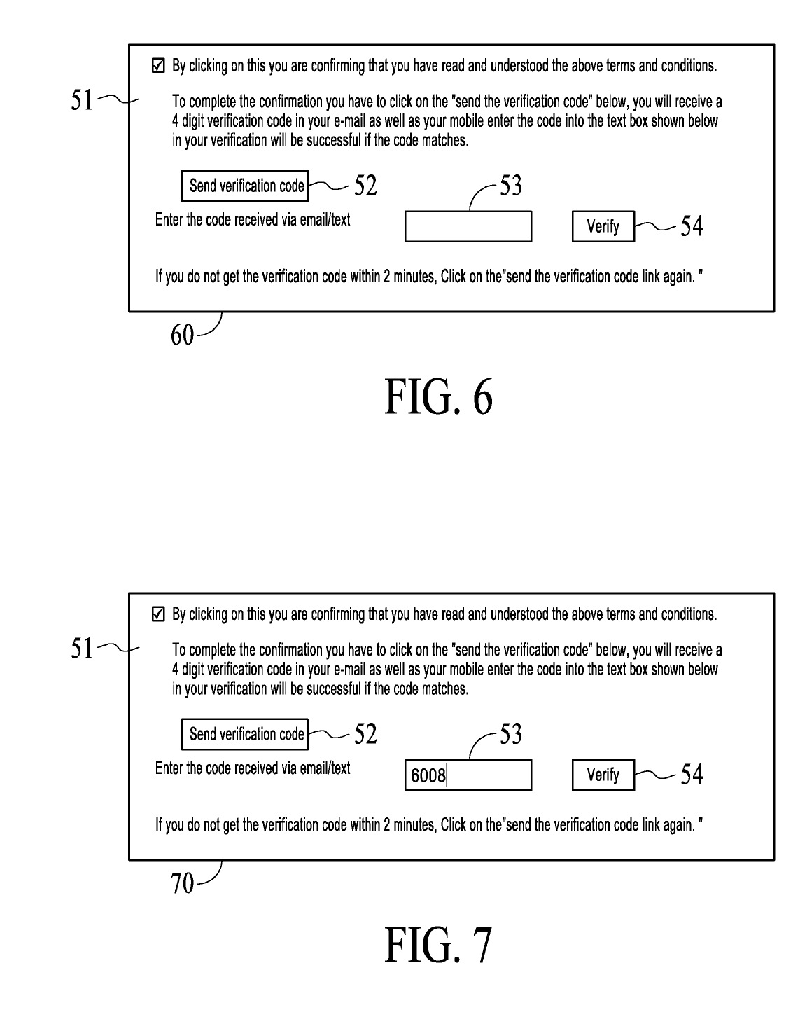

Reservation information is stored in database 23. In a block 31, a hotelier (if it is a hotel reservation) accesses reservations from database 23. This is illustrated in FIG. 4. FIG. 4 shows various panels of an interface used to access database 23. For example, the hotelier can access this interface remotely through Internet 10 or through a direct connection to e-commerce server 11. The series of panels shown in FIG. 4 can be displayed on a single screen or on multiple screens of the database interface.

In FIG. 4, a research panel 40 allows the hoteliers to search reservations based on criteria such as reservation data, selected hotel, reservation start date, reservation end date, and so on. Reservations that match search criteria are displayed in a reservation list details area 41 of panel 40. Where the database is for a merchant selling goods and services the panel information might include, for example, description of product or service, purchase price, other purchase data, shipping and tracking information, and so on.

Details of a reservation are displayed in a panel 42. Details include, for example, details about the hotel as well as contact details about a consumer. Reservation details include, for example, price, room number, dates for the reservation, and status of the reservation. For example, status can include indications that the reservation is “unconfirmed” or “confirmed”.

In a panel 43, reservation details for a selected reservation are displayed. Panel 43 includes a “send confirmation verification” button 43. This can be used to initiate a confirm process for the displayed reservation.

For example, in a block 33 (shown in FIG. 3), a hotelier selects the “send confirmation verification button” for the displayed reservation. As a result, in a block 34, a computer generated confirmation message will be sent to consumer for the reservation, as listed in panel 42 shown in FIG. 4. The computer generated confirmation message can be, for example, an e-mail, an SMS (text message), an instant message or another type of electronic message. The computer generated confirmation message will provide information about the reservation and request confirmation. The computer generated confirmation message will also contain a button labeled, for example, “Confirm Reservation”. The user can select the button to confirm the reservation.

Alternatively, or in addition, to allowing a hotelier to select “send confirmation verification button”, the verification process can be automated to start without a selection being made in a reservation system. For example, when a reservation through payment management system 25 (shown in FIG. 2) is made, this can automatically trigger confirmation as further described below. For example, PMS 25 receives a reservation request this act triggers confirmation control logic 24 to cause a computer generated confirmation message to be sent to the consumer for the reservation. The computer generated confirmation message will provide information about the reservation and request confirmation. The computer generated confirmation message will also contain a button labeled, for example, “Confirm Reservation”. The user can select the button to confirm the reservation. For example, the reservation will be placed into database 23 before or simultaneously with the confirmation e-mail being sent. Alternatively, the reservation will be placed into database 23 only upon completion of the reservation has been confirmed and the end user agrees to all merchant conditions of sale or reservations or other binding information.

In a block 35, the user clicks the confirmation button in the computer generated confirmation message. The confirmation button includes a link to a web page for the reservation. The web page shows terms and conditions for the reservation and requests confirmation. When the consumer selects the confirmation button and links to the web page, e-commerce server captures information about the computing device used to make the connection. For example, the captured information includes an internet protocol (IP) for the computing device. Captured information can also include caller ID information or any other information available in the consumer contact is through a phone system. This additional information can include an IP address for a cellular phone if available as well.

For example, FIG. 5 shows a simplified web page 50 where terms and conditions are described. The terms and conditions can be an agreement specific to a hotel or hotel chain, or can be a more standardized form that has auto fillers for consumer or hotel information. A confirmation check box 51, when checked by the consumer, indicates the consumer has read and agrees to the terms and condition. In a block 36, the consumer confirms agreement. For example, this is done by the user checking confirmation checkbox 51. For example, upon selecting confirmation checkbox 51, a send verification code button 52 is activated. For example, before activation, send verification code button 52 is shaded indicating it is inactive. Alternatively, send verification code button 52 is not shown at all until confirmation checkbox 51 is checked by the consumer. Alternatively, send verification code button 52 does not appear at all, but a verification code is sent upon the user selecting confirmation checkbox 51.

As illustrated by block 36, the consumer selects send verification code button 52 (or clicks confirmation checkbox 51 when send verification code button 52 is not used) to request a verification code. As illustrated by block 37, e-commerce server 11 will then send an e-mail message through the Internet 10 and/or will send a text (SMS) message through cell phone network 16 that will include a confirmation code. Alternatively, some other electronic messaging system is used. For example, the confirmation code is a four digit confirmation code. Alternatively, the confirmation has another number of digits or some other format. Alternative to using a confirmation code for verification, verification can be performed in another way. For example, calls can be recorded by e-commerce server using a voice over IP system. The voice recordings can be stored with other confirmation information.

Also, when the consumer selects send verification code button 52 to request a verification code, (or takes another action, such as clicking confirmation checkbox 51, that results in a verification code being sent), a box appears to allow the consumer to enter the verification code. This can occur, for example, by the appearance of a new web page or by modifying the displayed web page to include a box in which the user can enter the verification code. This is illustrated by FIG. 6 where in section 60, a box 53 appears and a verify button 54 appears.

As illustrated by a block 37, the consumer receives the verification code either by text or e-mail or by some other electronic messaging system. In a block 38, the user fills in the verification code into box 53 and selects verify button 54. This is illustrated by FIG. 7.

E-commerce server 11 will then verify the code and if correct, will redirect the user to a “Consumer Login” web page that will supply the user with all the details of the transaction. As illustrated by block 39, e-commerce server 11 will also send the consumer a confirmation copy of the information transaction, for example, by e-mail or by some other electronic messaging system. E-commerce server 11 stores the confirmation data, a copy of the documents agreed to by the consumer along with any captured information from the transaction, such as the internet protocol (IP) address information and any other information available from the transmission of data by e-mail, SMS text messages, other electronic messaging exchange, as well as information available from the consumer logging onto the web site to confirm the reservation and the included terms and conditions. Terms and conditions includes, for example, refund policy, cancellation policy, damage policies, privacy policies, any other terms or conditions related to the reservation as well as all the details of the reservation or purchase made.

The other evidence includes for example, recordation of the sending of the verification code and the use of the verification code to confirm the transaction plus any IP address information and cell phone information available from these transactions. Additionally, voice recording of calls can be made by e-commerce server, for example using voice over IP, and the recordings stored for additional confirmation information.

As illustrated by a block 40, at a predetermined time before the reservation date, for example 24 hours before the reservation date, e-commerce server 11 will send the consumer a reminder that the reservation is the following day. For example, the reminder is sent by text (SMS message), e-mail or another type of electronic message, or any combination of these. For example the text (or e-mail or other type of electronic message) might include a reminder of the terms and conditions of the hotel policy as agreed to by the consumer. Depending on the hotel policy, the predetermined time before the reservation date could also be 48 hours, or some other length of time before the reservation date.

While the above discusses verification of a reservation, similar verification process can be used to confirm other consumer commitments. For example, the confirmation can be a validation or verification of the purchase of goods or services, agreement to terms and conditions for a purchase, agreement to company policies and so on. For good or services, terms and conditions includes, for example, refund policy, cancellation policy, damage policies, privacy policies, any warranties or express consents granted by the source of the service or product, any other terms or conditions related to purchase of goods or services as well as al the details of the actual product or service purchase.

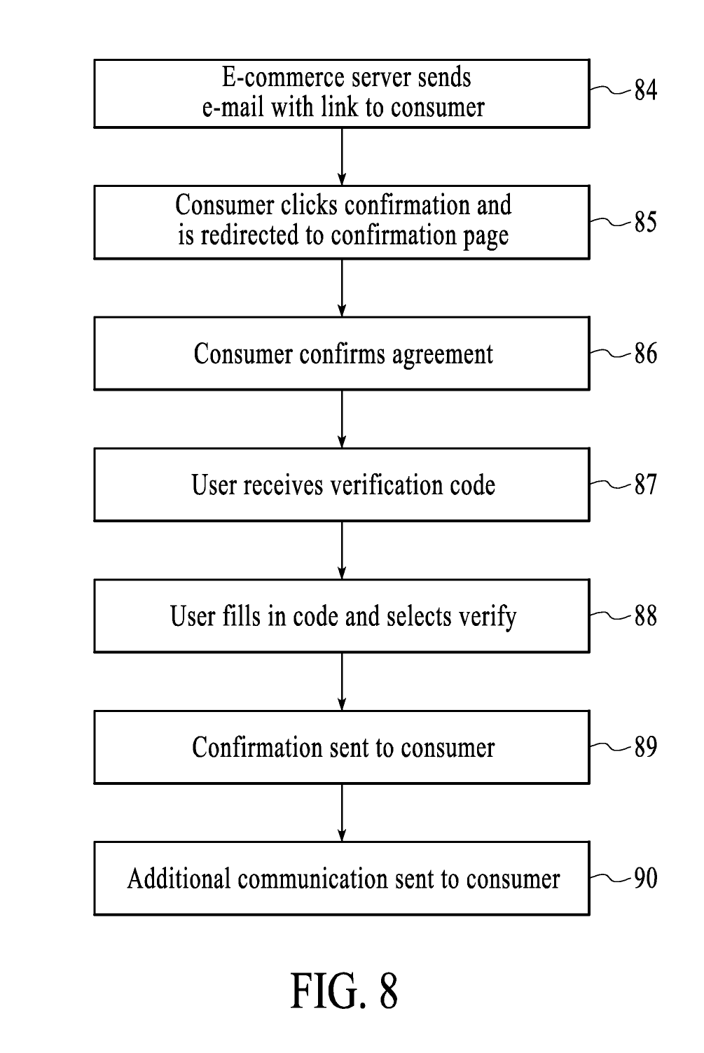

FIG. 8 represents how verification of a consumer commitment might be performed. For example, the consumer commitment pertains to validating purchase or delivery of goods or services, documenting agreement to website policies, confirming agreement with terms and conditions pertaining to the purchase of goods or services, validating other aspects of a transaction, providing tracking information and so on. The verification is obtained by using consumer supplied information to electronically contact the consumer and storing identifying information generated by the electronic contact process. This verification process is useful for any merchant that is accepting payments when the consumer is not face-to-face. For example, this is useful for internet payments, phone payments, mail payments, fax transactions or any transaction where the merchant and the consumer is not conducting business in a face to face environment.

In a block 84, once a consumer of goods or services makes a commitment or takes an action in an e-commerce transaction (e.g., through the Internet or when a user is in communication with a merchant who enters consumer information in a gateway using a virtual terminal, monitor, or other portal, etc.), a computer generated confirmation message is sent to the consumer. The computer generated confirmation message can be, for example, an e-mail, an SMS (text message), an instant message or another type of electronic message. For example, the consumer commitment is a confirmation of tracking information, delivery information, agreement to website policies, agreement to terms and conditions for a purchase of goods or services, an agreement to intellectual property rights and/or any other type of confirmation of a commitment intended to obviate a dispute between a business and a consumer, resulting, for example from a consumer later denying such commitment was ever made or intended as well as details of actual product or service purchase. The sending of the computer generated confirmation message can be triggered by a merchant making a selection in a database to send the computer generated confirmation message. Alternatively, a transaction or commitment performed using web server gateway 26 will trigger confirmation control logic 24 to send the computer generated confirmation message.

The computer generated confirmation message will provide information about the commitment and request confirmation. The computer generated confirmation message will also contain a button labeled, for example, “Confirm Commitment”. The user can select the button to confirm the commitment.

In a block 85, the user clicks the confirmation button. The confirmation button includes a link to a web page reiterating the consumer commitment. The web page shows terms and conditions for the commitment and requests confirmation. For example, the web page displays purchase data, all terms and conditions as well as detail of a product or service purchase.

The web page also includes a check box or some other selection mechanism, such as a place for consumer initials or signature, that indicates the consumer has read and agrees to the terms and condition. Information is captured as described further above.

In a block 86, the consumer checks the confirmation checkbox (or otherwise signals agreement). For example, upon selecting the confirmation checkbox, a send verification code button is activated. For example, before activation, “send the verification code button” is shaded indicating it is inactive. Alternatively, “send the verification code button” is not shown at all until the confirmation checkbox is checked by the consumer. Alternatively, “send the verification code button” does not appear at all, but a verification code is sent upon the user selecting the confirmation checkbox.

As illustrated by block 86, a verification code is sent to the consumer as a result of a consumer action. The verification code is sent, for example, by e-mail, an SMS (text) message or some other electronic messaging system. For example, the consumer action is clicking a confirmation check box and selecting a send verification code button or, for example, the consumer action is merely clicking the confirmation check box. As illustrated by block 87, e-commerce server 11 will send an e-mail message through the Internet 10 and/or will send a text (SMS) message through cell phone network 16 that will include a confirmation code. Alternatively, some other electronic messaging system is used. For example, the confirmation code is a four digit confirmation code. The confirmation code can be of different lengths or have a different format.

Also, when the consumer requests the verification code be sent (e.g., by clicking the confirmation checkbox and selecting the “send the verification code button”, or by merely clicking the confirmation checkbox or in some other way signaling agreement consumer commitment), a box appears to allow the consumer to enter the verification code. This can occur, for example, by the appearance of a new web page or by modifying the displayed web page to include a box in which the user can enter the verification code.

As illustrated by a block 87, the consumer receives the verification code either by text or e-mail or by some other electronic messaging system. In a block 88, the user fills in the verification code and selects a verify button or otherwise requests e-commerce server 11 to verify. For example, the verification can occur automatically, once an entry has been made to the verification box.

E-commerce server 11 will then verify the code and if correct, will redirect the user to a “Consumer Login” web page that will supply the user with all the details of the transaction. As illustrated by block 89, e-commerce server 11 will also send the consumer a confirmation copy of the information transaction, for example, by e-mail, SMS text message or by some other electronic messaging system. E-commerce server 11 stores the confirmation data, a copy of the documents agreed to by the consumer along with the internet protocol (IP) address information from the e-mail exchange as well as other evidence the transaction was complete and the user agreed to confirm the commitment and the included terms and conditions as well as all product and purchase data. The other evidence includes for example, recordation of the sending of the verification code and the use of the verification code to confirm the transaction plus any IP address information and cell phone information available from these transactions.

As illustrated by a block 90, e-commerce server 11 may send the consumer additional communications such as, for example, tracking information before shipment, product details, etc. The communication can be sent by text (SMS message), by e-mail or by another type of electronic message. For example the text (or e-mail or other type of electronic message or any combination of these) includes a reminder of the terms and conditions of the commitment as agreed to by the consumer, shipping and tracking information and so on.

If the consumer's reservation or commitment of purchase, for example, is made from an e-commerce site has been made for the first time, the credential of consumer for login will be sent to the user. E-commerce server 11 can confirm these using e-mail, SMS (text) or some other electronic communication. A consumer can use login identity and password to access a consumer home page where details of a reservation, transaction or commitment can be viewed. For example, a consumer is allowed to make changes to the reservation or other commitment or transaction or to cancel the reservation, product, services, transaction or other commitment depending upon the terms and conditions agreed to by the consumer. Requests outside these terms and conditions can be considered by a vendor on an ad hoc basis.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A computer implemented method for verifying a consumer commitment comprising:
sending a computer generated confirmation message in response to a consumer making a consumer commitment, the computer generated confirmation message containing a link to a web page reiterating the consumer commitment;
upon the consumer selecting the link in the computer generated confirmation message containing, collecting information identifying the consumer;
sending electronically a verification code to the consumer upon the consumer confirming the consumer commitment reiterated on the web page;
upon the consumer entering the verification code, storing information containing the consumer commitment, a record of the verification process and the collected information identifying the consumer to verify the consumer commitment.

2. A computer implemented method as in claim 1 wherein the collected information identifying the consumer includes an internet protocol (IP) address of a device used by the consumer.

3. A computer implemented method as in claim 1 wherein the verification code is sent by e-mail.

4. A computer implemented method as in claim 1 wherein the verification code is sent by a short message service (SMS) text message e-mail.

5. A computer implemented method as in claim 1 wherein the consumer commitment pertains to a hotel reservation.

6. A computer implemented method as in claim 1 wherein the consumer commitment concerns terms and conditions for a purchase of goods or services.

7. A computer implemented method as in claim 1 additionally comprising:
sending a reminder to the consumer before a required action of the consumer is scheduled to occur.

8. A computer implemented method as in claim 1 wherein the consumer confirms the consumer commitment reiterated on the web page by selecting a check box on the web page.

9. A computer implemented method as in claim 1 wherein the consumer confirms the consumer commitment reiterated on the web page by selecting a check box on the web page and the consumer selects a send verification code button so that when the consumer commitment is a transaction, the transaction will not be completed until the consumer commitment is validated and confirmed by a consumer.

10. A computer implemented method for confirming reservation reservations comprising:
sending a computer generated confirmation message for a reservation, the computer generated confirmation message containing a link to a web page reiterating details of the reservation;
upon the consumer selecting the link in the computer generated confirmation message containing, collecting information identifying the consumer;
sending electronically a verification code to the consumer upon the consumer confirming the reservation reiterated on the web page;
upon the consumer entering the verification code, storing information containing the reservation, a record of the verification process and the collected information identifying the consumer to verify the reservation.

11. A computer implemented method as in claim 10 wherein the collected information identifying the consumer includes an internet protocol (IP) address of a device used by the consumer.

12. A computer implemented method as in claim 10 wherein the verification code is sent by e-mail.

13. A computer implemented method as in claim 10 wherein the verification code is sent by a short message service (SMS) text message or by e-mail.

14. A computer implemented method as in claim 10 additionally comprising:
sending a reminder to the consumer before a check-in time for the reservation.

15. A computer implemented method as in claim 10 wherein the consumer confirms the reservation reiterated on the web page by selecting a check box on the web page.

16. A computer implemented method as in claim 10 wherein the consumer confirms the reservation reiterated on the web page by selecting a check box on the web page and the consumer selects a send verification code button.

17. A computer implemented method as in claim 10 wherein sending the computer generated confirmation message for the reservation is initiated by a hotelier selecting a reservation confirmation button on a listing for the reservation stored in a reservation database.

18. A computer implemented method as in claim 10 wherein the reservation is a hotel reservation.

19. A computer implemented method as in claim 10 wherein the reservation is a car reservation.

20. A computer implemented method as in claim 10 wherein the reservation is an e-commerce commitment.
